(19) United States
(12) Patent Application Publication
(10) Pub. No.: US 2015/0041544 A1
(43) Pub. Date: Feb. 12, 2015

(54) Bar Code Reading System

(71) Applicant: Mobilogics International Co., Ltd., Kaohsiung City (TW)

(72) Inventor: Cheng-Hung CHEN, Kaohsiung City (TW)

(73) Assignee: Mobilogics International Co., Ltd., Kaohsiung City (TW)

(21) Appl. No.: 13/960,591

(22) Filed: Aug. 6, 2013

(51) Int. Cl. G06K 7/10

(52) U.S. Cl. CPC G06K 7/1098
USPC 235/462.1; 235/462.15

(57) ABSTRACT

A bar code reading system comprises a handheld electronic device and a bar code reader. The handheld electronic device comprises an operation processing unit and a memory unit, and the bar code reader attached to the handheld electronic device comprises a housing, an output end and a bar code acquisition unit. The bar code acquisition unit is disposed in the housing, and the bar code acquisition unit is used to read a bar code, and convert the bar code to a digital signal; the bar code reader transmits the digital signal to a handheld electronic device through the output end. Wherein, the operation processing unit is used to process the digital signal, and store the digital signal in the memory unit.

### BACKGROUND OF THE INVENTION

1. Field of Invention

The present invention relates to a bar code reading system, and in particular, to the bar code reading system of a bar code reader attached to a cell phone.

2. Related Art

With the arrival of the information technology era and the advancement of the communications network technology, cell phones (also known as mobile phones) have become one of the most common communications tools. Cell phone products are becoming popular among more and more consumers owing to their small sizes, perfect portability, complete functions, and declining prices. People can communicate with friends or business partners timely through cell phones. Therefore, compared with conventional fixed line telephones, cell phones make communications more convenient and faster. Moreover, theoretically speaking, with the radio communications feature and message (short message or email) transmission function of the cell phones, users can receive messages from and send messages to each other at any place. A common cell phone is capable of completing a data (text) entering action by means of the keyboard thereof; however, keyboards of common cell phones are so small that it is inconvenient to enter data. Hence, the conventional text input manner of a cell phone is apparently inconvenient and defective in practice, and needs to be improved.

Mostly print the bar code on the packing surface of the products or their other boxes on the market, this bar code department in accordance with sure to encode principle compile, and then via one bar code scanning and distinguish system treated of scanner, the goods information that can represent this bar code, for instance such materials as trade name, number of the goods and price, etc. It read and got out, and then reaches the correct, fast and convenient automatic goods office procedure. The bar code scanner can roughly be divided into a regular type and holding type two kinds, among them, it is that scanning comes on the way of articles by sweeping the taking aim device that holding type sweeps the taking aim device, so it accords with the human engineering, convenient design that held that its appearance is usually adopted, relatively benefit users and hold and scan the homework; Right, as to be scanned article being in large quantity to take the scanning in succession for a long time, or it is the unable hold at being sweep taking aim device, way that make changes according to specific conditions of it soon should holding type fix at tabletop the scanners, and then carry on the scanning on this scanner with articles. The above-mentioned holding type scanner is fixed on the tabletop, because it is not regular that the goods are moved to the scanning position that sweep the taking aim device, when it is too big to act as the contained angle which reads the head and bar code label which is swept the taking aim device, may cause the state difficult to read, so scan commonly many times but read the awkward situation of the bar code, but inconvenience that but should change the scanning angle when the holding type scanner is regular for fear of being unable, it is the place that demands urgently to be improved in fact.

### SUMMARY OF THE INVENTION

The present invention provides a bar code reading system and particularly a bar code reader attaching to a cell phone, so as to make it more convenient to recognize and read a bar code.

The present invention provides a bar code reading system comprises a handheld electronic device and a bar code reader. The handheld electronic device comprises an operation processing unit and a memory unit. The bar code reader attached to the handheld electronic device comprises a housing, an output end and a bar code acquisition unit, the bar code acquisition unit is disposed in the housing, the bar code acquisition unit is used to read a bar code, and convert the bar code to a digital signal; the bar code reader is attached the digital signal to a handheld electronic device through the output end. Wherein, the operation processing unit is used to process the digital signal, and store the digital signal in the memory unit.

In an embodiment of the present invention, a power pack is disposed in the handheld electronic device to provide power for operations of devices, and the power pack is a battery.

In an embodiment of the present invention, the bar code reader is further provided with a light source, a lens assembly, a receiving unit, and a charge-coupled device (CCD), wherein the light source is a light source of laser/LED. The bar code reader shines the bar code by using the light source, and then the receiving unit receives a captured light, and converts a value of the reflected light to the digital signal.

In an embodiment of the present invention, the handheld electronic device is further provided with a control key, so as to operate the bar code reader to scan a bar code.

In an embodiment of the present invention, the handheld electronic device executes a bar code scanning program, so as to operate the digital signal for generating a bar code information, wherein the bar code scanning program performs a predetermined procedure based on the bar code information or analyzes the bar code information to obtain a digital information.

In an embodiment of the present invention, the bar code is a one-dimensional bar code.

In an embodiment of the present invention, the bar code is a two-dimensional bar code.

In an embodiment of the present invention, the bar code reading system is set for all mobile operating systems.

### BRIEF DESCRIPTION OF THE DRAWINGS

FIG. 1 is a block diagram of a bar code reading system and

FIG. 2 is a schematic view of an embodiment according to FIG. 1.

### DETAILED DESCRIPTION OF THE INVENTION

To make the features and advantages of the present invention more comprehensible, a specific embodiment is described in detail below with reference to the accompanying drawings.

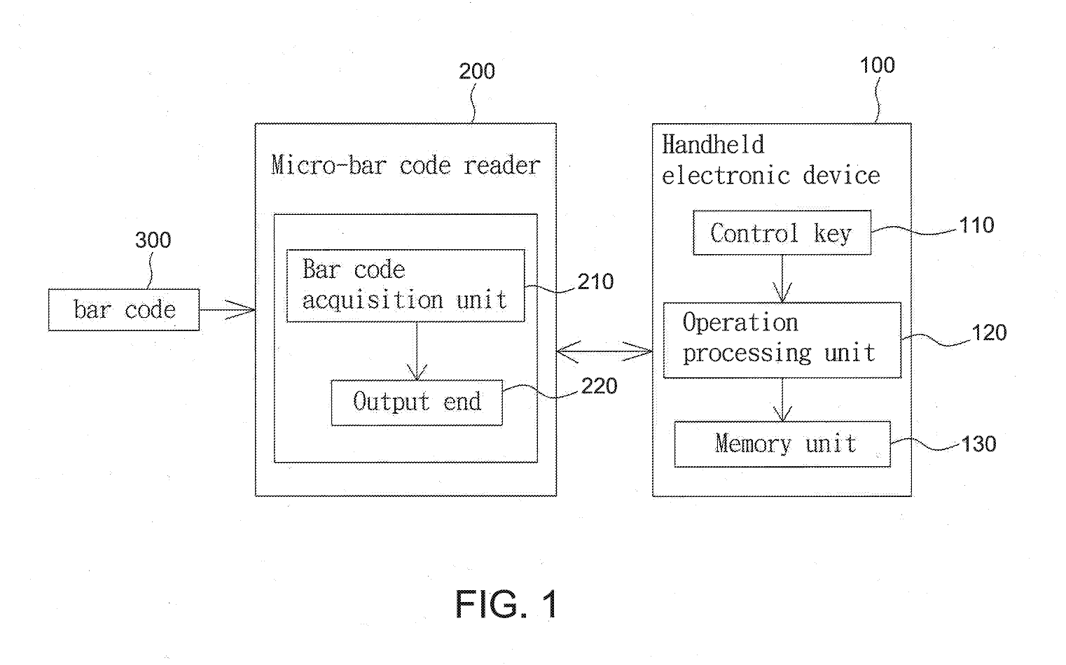

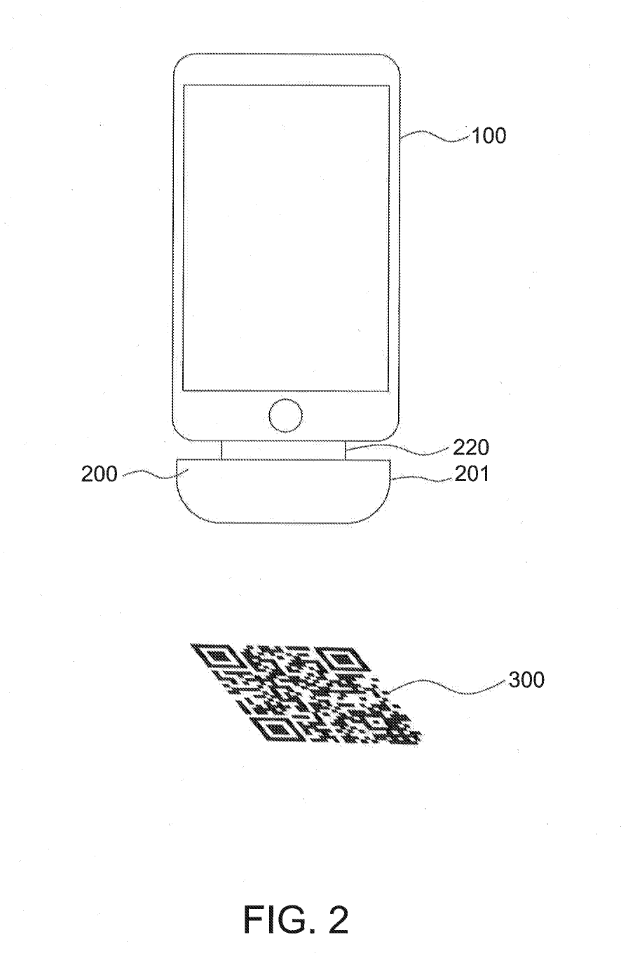

Referring to FIG. 1 and FIG. 2, FIG. 1 is a block diagram of a bar code reading system; and FIG. 2 is a schematic view of an embodiment according to FIG. 1. In FIG. 1, a bar code reader 200 comprises a housing 201, a bar code acquisition unit 210 and an output end 220. The bar code acquisition unit 210 is disposed in the housing 201 and is used to read a bar code 300, for example, a one-dimensional bar code or a two-dimensional bar code. So as to convert the bar code 300 to a digital signal; the bar code reader 200 is attached the digital signal to a handheld electronic device 100 through the output end 220.

An operation processing unit 120 and a memory unit 130 are disposed in the handheld electronic device 100; the operation processing unit 120 used to process the digital signal, and store the digital signal in the memory unit 130.

In this embodiment, a power pack is disposed in the handheld electronic device to provide power for operations of devices, and the power pack is a battery, wherein the light source is a light source of infrared ray. The bar code reader shines the bar code by using the light source, and then the receiving unit receives a reflected light, and converts a value of the reflected light to the digital signal.

In this embodiment, the bar code reader is further provided with a light source, a lens assembly, and a receiving unit.

In this embodiment, a control key is disposed in the handheld electronic device to operate the bar code reader to scan the bar code.

In this embodiment, the handheld electronic device executes a bar code scanning program, so as to operate the digital signal for generating a bar code information, wherein the bar code scanning program performs a predetermined procedure based on the bar code information or analyzes the bar code information to obtain a digital information.

In conclusion, through the combination of a bar code reader subject to miniaturization design and a transmission interface module, the bar code reader of the present invention is more portable as a whole. In addition, further considering the practicability, the present invention establishes an information link between the transmission interface module and a universal handheld electronic device, and control is achieved through the operation of the handheld electronic device. In this way, the use cost of the bar code reader is reduced, and the use of the bar code reader is less complex. Hence, the implementation of the present invention achieves the purpose of providing a plug-and-play bar code scanner which is portable and convenient to use, can be used together with a handheld electronic device for all mobile operating systems, and has a plug-and-play function. The present invention accelerates the popularization of the bar code in the market of common commercial applications.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bar code reading system comprising:
a handheld electronic device, comprising:
an operation processing unit; and
a memory unit, and
a bar code reader, attached to the handheld electronic device, comprising:
a housing;
an output end; and
a bar code acquisition unit, disposed in the housing, and the bar code acquisition unit is used to read a bar code and converts the bar code to a digital signal, and the bar code reader is used to transmit the digital signal to the handheld electronic device through the output end,
wherein the operation processing unit is used to process the digital signal, and store the digital signal in the memory unit.

2. The bar code reading system according to claim 1, wherein the bar code reader further comprises a light source, a lens assembly, and a receiving unit, and the light source, the lens assembly, the receiving unit, and a charge-coupled device (CCD) are disposed in the housing.

3. The bar code reading system according to claim 2, wherein the light source is a light source of laser/LED.

4. The bar code reading system according to claim 2, wherein the bar code reader scans the bar code by using the light source, and then the receiving unit receives a captured light, and converts a value of the reflected light to the digital signal.

5. The bar code reading system according to claim 1, wherein a power pack is disposed in the handheld electronic device to provide power for operations, and the power pack is a battery.

6. The bar code reading system according to claim 1, wherein a control key is disposed in the handheld electronic device to control the bar code reader to scan the bar code.

7. The bar code reading system according to claim 1, wherein the handheld electronic device executes a bar code scanning program, so as to operate the digital signal for generating a bar code information, wherein the bar code scanning program performs a predetermined procedure based on the bar code information or analyzes the bar code information to obtain a digital information.

8. The bar code reading system according to claim 1, wherein the bar code is a one-dimensional bar code.

9. The bar code reading system according to claim 1, wherein the bar code is a two-dimensional bar code.

10. The bar code reading system according to claim 1, wherein the bar code reading system is set for all mobile operating systems.
